(19) United States
(12) Patent Application Publication
(10) Pub. No.: US 2019/0049666 A1
(43) Pub. Date: Feb. 14, 2019

(54) Method And Systems For All Optical Tunable Equalizers

(71) Applicant: Luxtera, Inc., Carlsbad, CA (US)

(72) Inventor: Brian Welch, San Diego, CA (US)

(21) Appl. No.: 16/059,328

(22) Filed: Aug. 9, 2018

Related U.S. Application Data
(60) Provisional application No. 62/544,792, filed on Aug. 12, 2017.
(60) Provisional application No. 62/544,793, filed on Aug. 12, 2017.

(51) Int. Cl. G02B 6/126; G02B 6/42; H04B 10/40; H04B 10/25

(52) U.S. Cl. CPC G02B 6/126; G02B 6/42; G02B 2006/12147; H04B 10/25; H04B 10/40

(57) ABSTRACT

Methods and systems for all optical tunable equalizers may include an optical modulator comprising an input waveguide, first and second directional couplers, phase modulators, an optical delay, and an optical attenuator. The optical modulator may be operable to receive an input optical signal via the input waveguide, couple a portion of the input optical signal to a second waveguide via the first directional coupler, modulate a phase of optical signals in the input waveguide and the second waveguide using the phase modulators, and couple a feedback optical signal to the first directional coupler via the second directional coupler, the optical delay, and the optical attenuator. The optical modulator may be operable to communicate an output signal of said optical modulator from a first output of the second directional coupler. The optical modulator may be operable to communicate the feedback optical signal from a second output of the second directional coupler.

### CROSS-REFERENCE TO RELATED APPLICATIONS/INCORPORATION BY REFERENCE

This application claims priority to and the benefit of U.S. Provisional Application. Nos. 62/544,792 and 62/544,793 both filed on Aug. 12, 2017, each of which is hereby incorporated herein by reference in its entirety.

### FIELD

Aspects of the present disclosure relate to electronic components. More specifically, certain implementations of the present disclosure relate to methods and systems for all optical tunable equalizers.

### BACKGROUND

Conventional approaches for signal equalization may be costly, cumbersome, and/or inefficient—e.g., they may be complex and/or time consuming, and/or may have limited responsivity due to losses.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

Systems and methods are provided for all optical tunable equalizers, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1A is a block diagram of a photonically-enabled integrated circuit with an all optical tunable equalizer, in accordance with an example embodiment of the disclosure.

FIG. 1B is a diagram illustrating an exemplary photonically-enabled integrated circuit, in accordance with an example embodiment of the disclosure.

FIG. 1C is a diagram illustrating a photonically-enabled integrated circuit coupled to an optical fiber cable, in accordance with an example embodiment of the disclosure.

FIG. 2A is a schematic illustrating an all optical tunable feedback equalizer, in accordance with an embodiment of the disclosure.

FIG. 2B illustrates eye patterns with and without optical feedback in a phase modulator, in accordance with an example embodiment of the disclosure.

FIG. 3A is a schematic illustrating an all optical tunable feed forward equalizer, in accordance with an embodiment of the disclosure.

FIG. 3B illustrates eye patterns with and without optical feedback in a phase modulator, in accordance with an example embodiment of the disclosure.

### DETAILED DESCRIPTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry or a device is “operable” to perform a function whenever the circuitry or device comprises the necessary hardware and code (if any is necessary) to perform the function, regardless of whether performance of the function is disabled or not enabled (e.g., by a user-configurable setting, factory trim, etc.).

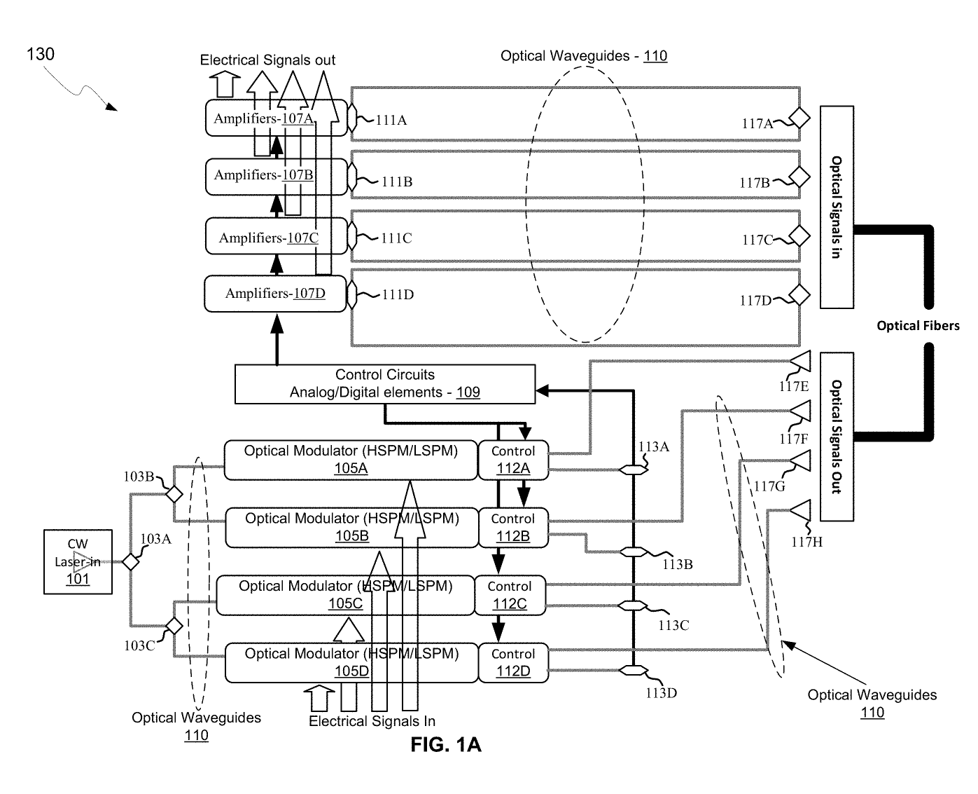

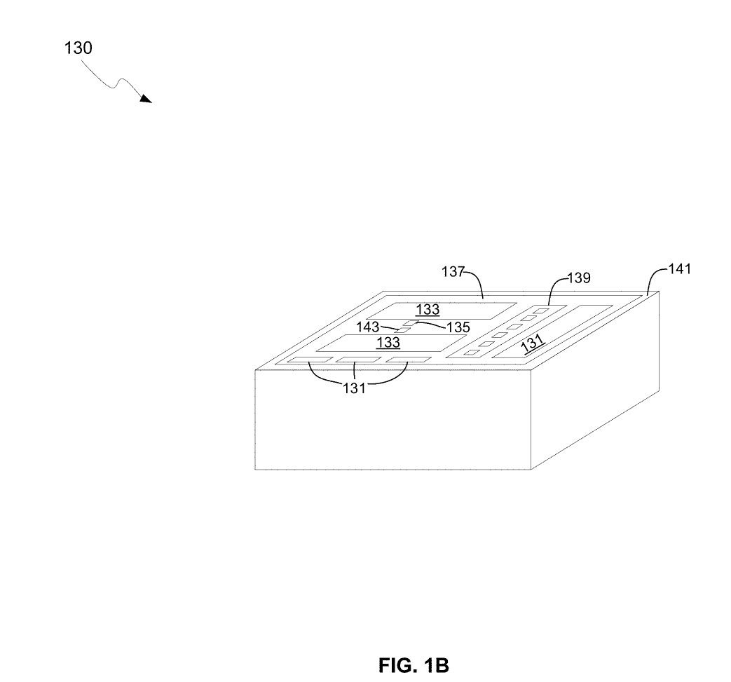

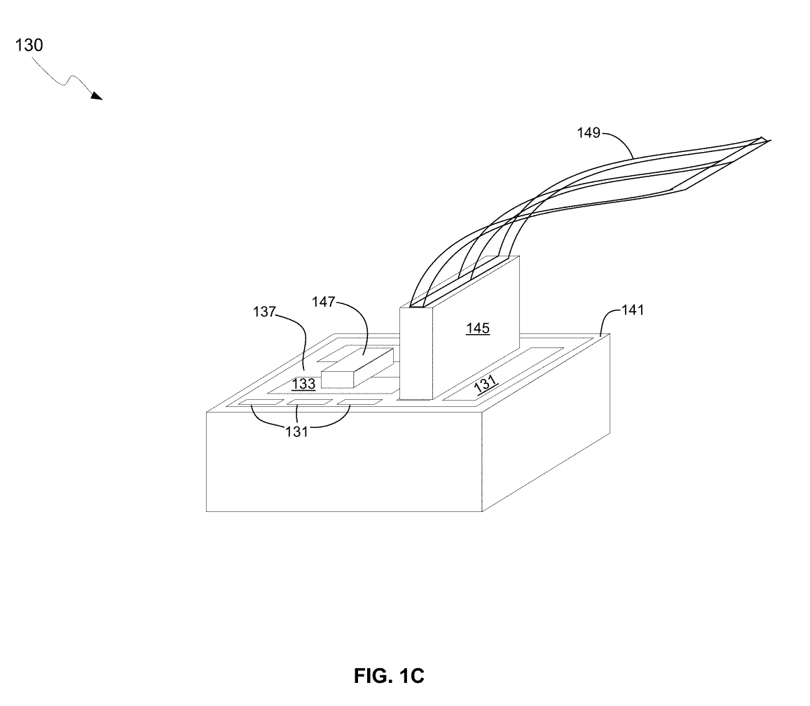

FIG. 1A is a block diagram of a photonically-enabled integrated circuit with an all optical tunable equalizer, in accordance with an example embodiment of the disclosure. Referring to FIG. 1A, there are shown optoelectronic devices on a photonically-enabled integrated circuit 130 comprising optical modulators 105A-105D, photodiodes 111A-111D, monitor photodiodes 113A-113D, and optical devices comprising couplers 103A-103C and grating couplers 117A-117H. There are also shown electrical devices and circuits comprising amplifiers 107A-107D, analog and digital control circuits 109, and control sections 112A-112D. The amplifiers 107A-107D may comprise transimpedance and limiting amplifiers (TIA/LAs), for example.

In an example scenario, the photonically-enabled integrated circuit 130 comprises a CMOS photonics die with a laser assembly 101 coupled to the top surface of the IC 130. The laser assembly 101 may comprise one or more semiconductor lasers with isolators, lenses, and/or rotators for directing one or more continuous-wave (CW) optical signals to the coupler 103A. The photonically-enabled integrated circuit 130 may comprise a single chip, or may be integrated on a plurality of die, such as with one or more electronics die and one or more photonics die.

Optical signals are communicated between optical and optoelectronic devices via optical waveguides 110 fabricated in the photonically-enabled integrated circuit 130. Single-mode or multi-mode waveguides may be used in photonic integrated circuits. Single-mode operation enables direct connection to optical signal processing and networking elements. The term “single-mode” may be used for waveguides that support a single mode for each of the two polarizations, transverse-electric (TE) and transverse-magnetic (TM), or for waveguides that are truly single mode and only support one mode. Such one mode may have, for example, a polarization that is TE, which comprises an electric field parallel to the substrate supporting the waveguides. Two typical waveguide cross-sections that are utilized comprise strip waveguides and rib waveguides. Strip waveguides typically comprise a rectangular cross-section, whereas rib waveguides comprise a rib section on top of a waveguide slab. Of course, other waveguide cross section types are also contemplated and within the scope of the disclosure.

In an example scenario, the couplers 103A-103C may comprise low-loss Y-junction power splitters where coupler 103A receives an optical signal from the laser assembly 101 and splits the signal to two branches that direct the optical signals to the couplers 103B and 103C, which split the optical signal once more, resulting in four roughly equal power optical signals.

The optical power splitter, may comprise at least one input waveguide and at least two output waveguides. The couplers 103A-103C shown in FIG. 1A illustrate 1-by-2 splitters, which divide the optical power in one waveguide into two other waveguides evenly. These Y-junction splitters may be used in multiple locations in an optoelectronic system, such as in a Mach-Zehnder interferometer (MZI) modulator, e.g., the optical modulators 105A-105D, where a splitter and a combiner are needed, since a power combiner can be a splitter used in reverse.

The optical modulators 105A-105D comprise Mach-Zehnder or ring modulators, for example, and enable the modulation of the continuous-wave (CW) laser input signal. The optical modulators 105A-105D may comprise high-speed and low-speed phase modulation sections and are controlled by the control sections 112A-112D. The high-speed phase modulation section of the optical modulators 105A-105D may modulate a CW light source signal with a data signal. The low-speed phase modulation section of the optical modulators 105A-105D may compensate for slowly varying phase factors such as those induced by mismatch between the waveguides, waveguide temperature, or waveguide stress and is referred to as the passive phase, or the passive biasing of the MZI.

In an example scenario, the high-speed optical phase modulators may operate based on the free carrier dispersion effect and may demonstrate a high overlap between the free carrier modulation region and the optical mode. High-speed phase modulation of an optical mode propagating in a waveguide is the building block of several types of signal encoding used for high data rate optical communications. Speed in the several Gb/s may be required to sustain the high data rates used in modern optical links and can be achieved in integrated Si photonics by modulating the depletion region of a PN junction placed across the waveguide carrying the optical beam. In order to increase the modulation efficiency and minimize the loss, the overlap between the optical mode and the depletion region of the PN junction must be carefully optimized.

One output of each of the optical modulators 105A-105D may be optically coupled via the waveguides 110 to the grating couplers 117E-117H. The other outputs of the optical modulators 105A-105D may be optically coupled to monitor photodiodes 113A-113D to provide a feedback path. The IC 130 may utilize waveguide based optical modulation and receiving functions. Accordingly, the receiver may employ an integrated waveguide photo-detector (PD), which may be implemented with epitaxial germanium/SiGe films deposited directly on silicon, for example.

The grating couplers 117A-117H may comprise optical gratings that enable coupling of light into and out of the photonically-enabled integrated circuit 130. The grating couplers 117A-117D may be utilized to couple light received from optical fibers into the photonically-enabled integrated circuit 130, and the grating couplers 117E-117H may be utilized to couple light from the photonically-enabled integrated circuit 130 into optical fibers. The grating couplers 117A-117H may comprise single polarization grating couplers (SPGC) and/or polarization splitting grating couplers (PSGC). In instances where a PSGC is utilized, two input, or output, waveguides may be utilized.

The optical fibers may be epoxied, for example, to the CMOS chip, and may be aligned at an angle from normal to the surface of the photonically-enabled integrated circuit 130 to optimize coupling efficiency. In an example embodiment, the optical fibers may comprise single-mode fiber (SMF) and/or polarization-maintaining fiber (PMF).

In another exemplary embodiment illustrated in FIG. 1B, optical signals may be communicated directly into the surface of the photonically-enabled integrated circuit 130 without optical fibers by directing a light source on an optical coupling device in the chip, such as the light source interface 135 and/or the optical fiber interface 139. This may be accomplished with directed laser sources and/or optical sources on another chip flip-chip bonded to the photonically-enabled integrated circuit 130.

The photodiodes 111A-111D may convert optical signals received from the grating couplers 117A-117D into electrical signals that are communicated to the amplifiers 107A-107D for processing. In another embodiment of the disclosure, the photodiodes 111A-111D may comprise high-speed heterojunction phototransistors, for example, and may comprise germanium (Ge) in the collector and base regions for absorption in the 1.3-1.6 μm optical wavelength range, and may be integrated on a CMOS silicon-on-insulator (SOI) wafer.

The analog and digital control circuits 109 may control gain levels or other parameters in the operation of the amplifiers 107A-107D, which may then communicate electrical signals off the photonically-enabled integrated circuit 130. The control sections 112A-112D comprise electronic circuitry that enables modulation of the CW laser signal received from the splitters 103A-103C. The optical modulators 105A-105D may require high-speed electrical signals to modulate the refractive index in respective branches of a Mach-Zehnder interferometer (MZI), for example. In an example embodiment, the control sections 112A-112D may include sink and/or source driver electronics that may enable a bidirectional link utilizing a single laser.

In operation, the photonically-enabled integrated circuit 130 may be operable to transmit and/or receive and process optical signals. Optical signals may be received from optical fibers by the grating couplers 117A-117D and converted to electrical signals by the photodetectors 111A-111D. The electrical signals may be amplified by transimpedance amplifiers in the amplifiers 107A-107D, for example, and subsequently communicated to other electronic circuitry, not shown, in the photonically-enabled integrated circuit 130.

Integrated photonics platforms allow the full functionality of an optical transceiver to be integrated on a single chip. An optical transceiver chip contains optoelectronic circuits that create and process the optical/electrical signals on the transmitter (Tx) and the receiver (Rx) sides, as well as optical interfaces that couple the optical signals to and from a fiber. The signal processing functionality may include modulating the optical carrier, detecting the optical signal, splitting or combining data streams, and multiplexing or demultiplexing data on carriers with different wavelengths.

One of the most important commercial applications of silicon photonics is to make high speed optical transceivers, i.e., ICs that have optoelectronic transmission (Tx) and receiving (Rx) functionality integrated in the same chip. The input to such an IC is either a high speed electrical data-stream that is encoded onto the Tx outputs of the chip by modulating the light from a laser or an optical data-stream that is received by integrated photo-detectors and converted into a suitable electrical signal by going through a Trans-impedance Amplifier (TIA)/Limiting Amplifier (LA) chain. Such silicon photonics transceiver links have been successfully implemented at baud-rates in the tens of GHz.

As baud rates increase, optical waveform shaping becomes more difficult, and achieving high transmitter bandwidth via linear techniques is increasingly difficult and/or power hungry. In an example embodiment of the disclosure, the complementary or inverted output of an MZI may be fed back to the quiet input of the MZI, i.e. to the input that does not receive the input laser signal, to create a feedback equalizer (DFE). The feedback path may comprise attenuation and delay elements. In this configuration, an inverted copy of the MZI signal may be attenuated, delayed, and fed back into the unused MZI input. The equalization amplitude may be controlled by varying phase offset between the signals to create constructive/destructive interference. Benefits of this embodiment comprise low power requirements with no added high speed elements, no jitter is added, and may be used to provide pre-emphasis and/or de-emphasis as desired.

In another example embodiment of the disclosure, a complementary or inverted output of the MZI may be delayed and summed with the main MZI output signal, to create an optical feed forward equalizer. A complementary or inverted path may comprise attenuation and delay elements. In this configuration, an inverted copy of the MZI signal may be delayed and summed with the main signal. The equalization amplitude may be controlled by varying phase offset between the signals to create constructive/destructive interference. Benefits of this embodiment comprise low power requirements with no added high speed elements, no jitter is added, and may provide pre-emphasis or de-emphasis.

FIG. 1B is a diagram illustrating an exemplary photonically-enabled integrated circuit, in accordance with an example embodiment of the disclosure. Referring to FIG. 1B, there is shown the photonically-enabled integrated circuit 130 comprising electronic devices/circuits 131, optical and optoelectronic devices 133, a light source interface 135, a chip front surface 137, an optical fiber interface 139, CMOS guard ring 141, and a surface-illuminated monitor photodiode 143.

The light source interface 135 and the optical fiber interface 139 comprise grating couplers, for example, that enable coupling of light signals via the CMOS chip surface 137, as opposed to the edges of the chip as with conventional edge-emitting/receiving devices. Coupling light signals via the chip surface 137 enables the use of the CMOS guard ring 141 which protects the chip mechanically and prevents the entry of contaminants via the chip edge.

The electronic devices/circuits 131 comprise circuitry such as the amplifiers 107A-107D and the analog and digital control circuits 109 described with respect to FIG. 1A, for example. The optical and optoelectronic devices 133 comprise devices such as the couplers 103A-103C, optical terminations, grating couplers 117A-117H, optical modulators 105A-105D, high-speed heterojunction photodiodes 111A-111D, and monitor photodiodes 113A-113D.

In an example scenario, the monitor photodiodes may comprise feedback paths for the optoelectronic transceivers in the IC 130, thereby enabling a built-in self-test for transceivers.

FIG. 1C is a diagram illustrating a photonically-enabled integrated circuit coupled to an optical fiber cable, in accordance with an example embodiment of the disclosure. Referring to FIG. 1C, there is shown the photonically-enabled integrated circuit 130 comprising the chip surface 137, and the CMOS guard ring 141. There are also shown a fiber-to-chip coupler 145, an optical fiber cable 149, and an optical source assembly 147.

The photonically-enabled integrated circuit 130 comprises the electronic devices/circuits 131, the optical and optoelectronic devices 133, the light source interface 135, the chip surface 137, and the CMOS guard ring 141, and may be as described with respect to FIG. 1B for example.

In an example embodiment, the optical fiber cable may be affixed, via epoxy for example, to the CMOS chip surface 137. The fiber chip coupler 145 enables the physical coupling of the optical fiber cable 149 to the photonically-enabled integrated circuit 130.

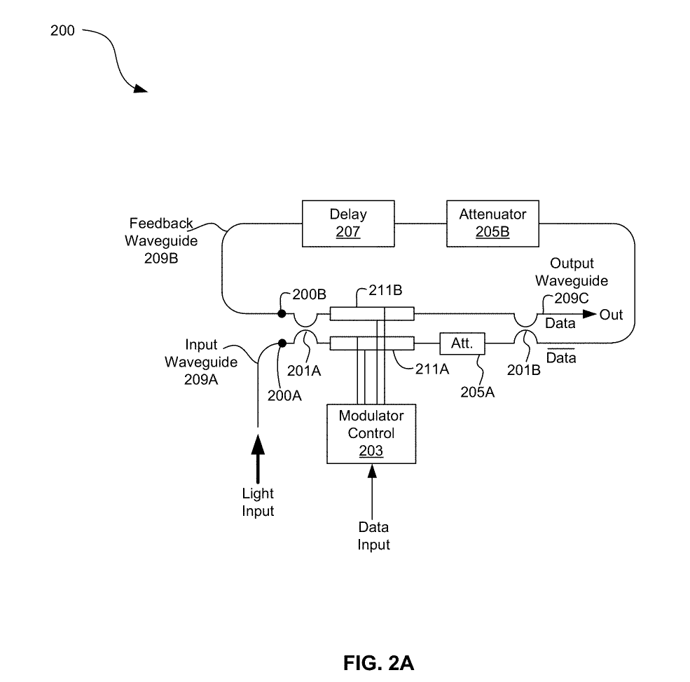

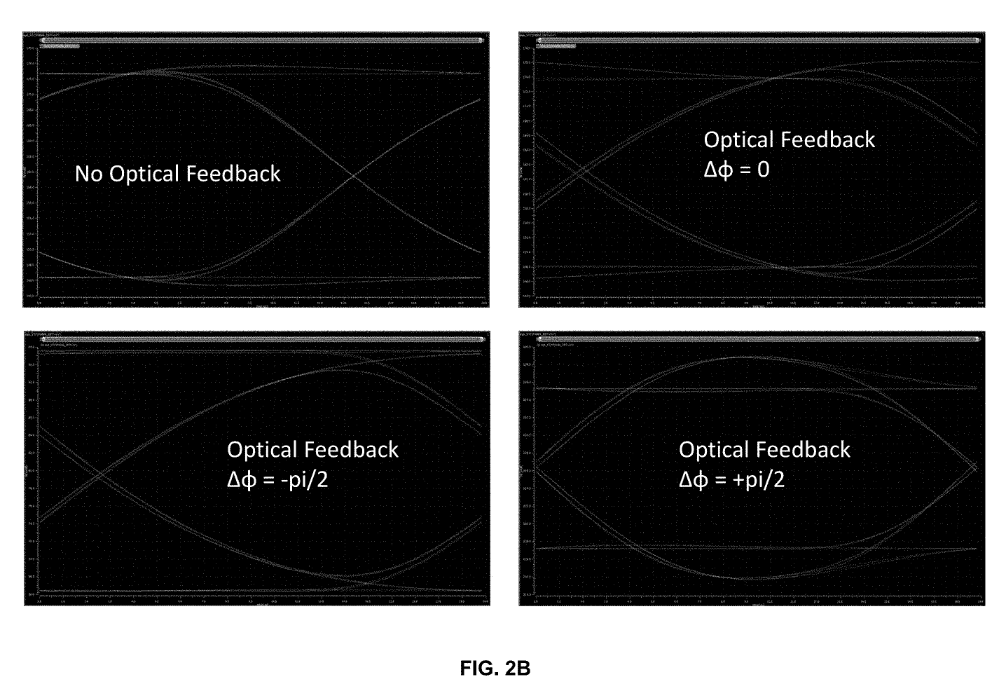

FIG. 2A is a schematic illustrating an all optical tunable feedback equalizer, in accordance with an embodiment of the disclosure Referring to FIG. 2A, there is shown a modulator 200 comprising taps 201A and 201B, modulator control 203, attenuators 205A and 205B, a delay element 207, waveguides 209A and 209B, and phase modulation regions 211A and 211B. The modulator 200 may comprise a Mach-Zehnder Interferometer, for example, with inputs 200A and 200B, and may be operable to receive a light input and modulate the intensity to generate a modulated output based on a received electrical input signal.

The taps 201A and 201B comprise regions of the modulator 200 where the waveguides 209A-209C are in close proximity and enable the coupling of optical signals from one waveguide to the adjacent one. The delay element 207 may comprise an extended length of waveguide, for example, for providing a desired delay to the optical signal, or may comprise selectable lengths of waveguide via one or more optical switches, for example.

The modulator control 203 may comprise circuitry for driving the phase modulation regions 211A and 211B, and may include drivers, for example, for providing biasing voltage and data signals to the modulation regions 211A and 211B. The attenuators 205A and 205B may comprise sections in the waveguides 209A-209C where optical signals may be attenuated a desired amount, such as by incorporating a pn junction in the waveguides 209A-209C, and may be configurable by application of a voltage, for example. The attenuators 205A and 205B may comprise low-speed controlled elements, for example, like the PIN-PM modulators used in an MZI. Each of the configurable elements, such as the attenuators 205A and 205B, delay element 207, and modulator control 203 may be configured by a processor or other control circuitry, such as the control circuits 109 described with respect to FIG. 1A.

The phase modulation regions 211A and 211B may comprise PN junctions in the waveguide, where an applied bias changes the index of refraction in the waveguide, thereby causing a phase change, which causes constructive/destructive interference after the tap 201B, thereby modulating the optical signals and generating output signals labeled Data and Data_bar for the complementary or inverted signal. The signal labeled Data may comprise the output signal of the modulator 200 and the signal labeled Data_bar comprises a feedback signal for the modulator 200. The complementary or inverted signal may be attenuated by a desired amount by the attenuator 205B and delayed by the delay element 207 before being communicated to the normally unused input 200B of the modulator 200.

Since the architecture of an MZI inherently results in the two outputs having the same high speed data encoded on them (with one simply being the complement of the other), when light is incident on the chip and electrical modulation is applied to the Tx driver, the data-stream in the optical loopback is the same as the one in the main data path.

In operation, a CW optical signal may be coupled into the modulator 200 via the input waveguide 209A, where a portion of the input signal is coupled to the adjacent waveguide in tap 201A. A data signal, Data Input, may be applied to the phase modulation regions 211A and 211B by the modulator control 203 thereby changing the phase of the optical signals travelling through the waveguides. The attenuator 205A may attenuate one of the resulting optical signals before a portion of each signal is coupled to the adjacent waveguide in tap 201B, resulting in constructive or destructive interference based on the phase of each signal.

The output signal of the modulator, Data, may be communicated from output waveguide 209C, while the complementary signal may be fed back via feedback waveguide 209B. This signal may be attenuated and delayed by the attenuator 205B and delay 207, respectively, before a portion of this delayed and attenuated signal is coupled with the input signal at the tap 201A. In this manner, an inverted copy of the modulator signal 200 may be attenuated, delayed, and fed back into the normally unused modulator input 200B. The equalization amplitude may be controlled by varying phase offset between the signals using the delay element 207, which may be configurable, to create constructive/destructive interference. Benefits of this embodiment comprise low power requirements with no added high speed elements, no jitter being added, and it may provide pre-emphasis or de-emphasis for the input signal.

FIG. 2B illustrates eye patterns with and without optical feedback in a phase modulator, in accordance with an example embodiment of the disclosure. Referring to FIG. 2B, there is shown four eye patterns, with the upper left illustrating no optical feedback, and the other three with optical feedback with a phase change of 0, +π/2, and −π/2. As shown by the changes in the eye pattern with change in phase, it is evident that subsequent changes in pulse shape may be compensated for by tuning the feedback path.

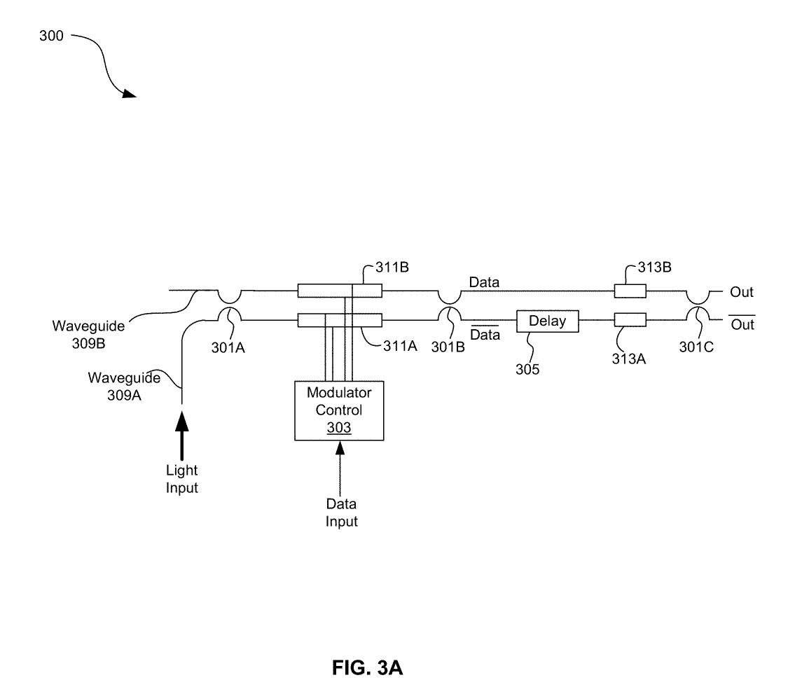

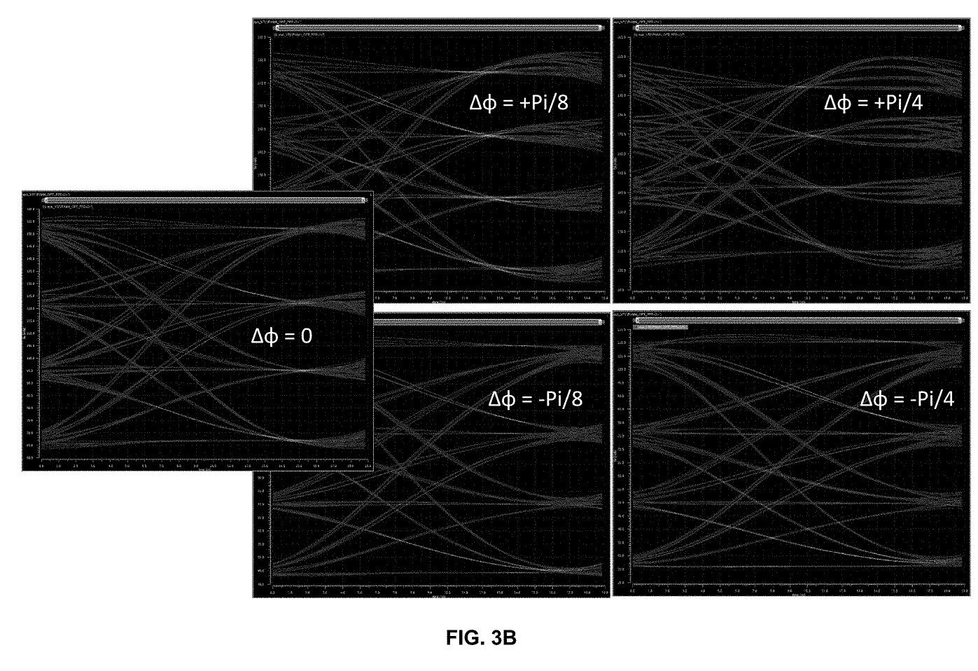

FIG. 3A is a schematic illustrating an all optical tunable feed forward equalizer, in accordance with an embodiment of the disclosure. Referring to FIG. 3A, there is shown a modulator 300 comprising taps 301A-301C, modulator control 303, a delay element 305, waveguides 309A and 309B, phase modulation regions 311A and 311B, and phase shifters 313A and 313B. The modulator 300 may comprise a Mach-Zehnder Interferometer, for example, and may be operable to receive a light input and modulate the intensity to generate a modulated output based on a received electrical input signal.

The taps 301A and 301B comprise regions of the modulator 300 where the waveguides 309A and 309B are in close proximity and enable the coupling of optical signals from one waveguide to the adjacent one. The delay element 305 may comprise an extended length of waveguide for providing a desired delay to the optical signal, or selectable lengths of waveguides via one or more optical switches, for example. Each of the configurable elements, such as the delay element 305, phase shifters 313A and 313B, and modulator control 303 may be configured by a processor or other control circuitry, such as the control circuits 109 described with respect to FIG. 1A for example.

The modulator control 303 may comprise circuitry for driving the phase modulation regions 311A and 311B, and may include drivers, for example, for providing biasing voltage and data signals to the modulation regions 311A and 311B. The attenuators 305A and 305B may comprise sections in the waveguides 209 where optical signals may be attenuated a desired amount, such as by incorporating an absorbing material in or on the waveguides 309A and/or 309B, and may be configurable by application of a voltage, for example.

The phase modulation regions 311A and 311B may comprise PN junctions in the waveguide, for example, where an applied bias changes the index of refraction in the waveguide, thereby causing a phase change, which causes constructive/destructive interference after the tap 301B. This results in modulated optical signals labeled Data and Complementary or inverted. The phase shifters 313A and 313B may comprise low-speed controlled elements, for example, like the PIN-PM modulators used in an MZI. The feedforward configuration acts like an MZI where an interference pattern is created between the signal and its inverted copy.

In operation, a CW optical signal may be coupled into the modulator 300 via the input waveguide 309A, where a portion of the input signal is coupled to the adjacent waveguide in tap 301A. A data signal, Data Input, may be applied to the phase modulation regions 311A and 311B by the modulator control 303, thereby changing the phase of the optical signals travelling through the waveguides 309A and 309B. The delay 305 may delay the optical signal in waveguide 309A and the phase shifters 313A and 313B may provide individually controllable phase shift to the signals in each waveguide 309A and 309B, before a portion of each signal is coupled to the adjacent waveguide in tap 301C, resulting in constructive or destructive interference based on the phase of each signal.

The signal labeled Data may comprise the main output signal of the modulator 300 and the signal labeled Complementary or inverted comprises a feed forward signal for the modulator 300. The Complementary or inverted signal may be delayed by a desired amount by the delay element 305 before the delayed signal and the main output signal, Data, may be phase shifted by the phase shifters 313A and 313B. The phase shifted signals may then be communicated to the tap 301C thereby generating the output signals Out and Out_bar. In an example scenario, the tap 301C comprises a 3-10% tap.

In this configuration, an inverted copy of the MZI signal may be delayed and summed with the main signal. The equalization amplitude may be controlled by varying phase offset between the signals to create constructive/destructive interference. Benefits of this embodiment comprise low power requirements with no added high speed elements, no jitter is added, and may provide pre-emphasis or de-emphasis.

FIG. 3B illustrates eye patterns with and without optical feedback in a phase modulator, in accordance with an example embodiment of the disclosure. Referring to FIG. 3B, there is shown four eye patterns, with the upper left illustrating no optical feedback, and the other three with optical feedback with a phase change of 0, +π/2, and −π/2. As shown by the changes in the eye pattern with change in phase, it is evident that subsequent changes in link bandwidth may be compensated for by tuning the phase change between the main signal and the inverted signal, demonstrating feed-forward equalization.

In an example embodiment of the disclosure, a method and system is described for all optical tunable equalizers and may comprise an optical modulator comprising an input waveguide, first and second directional couplers, phase modulators, an optical delay, and an optical attenuator. The optical modulator may be operable to receive an input optical signal via the input waveguide, couple a portion of the input optical signal to a second waveguide via the first directional coupler, modulate a phase of optical signals in the input waveguide and the second waveguide using the phase modulators, and couple a feedback optical signal to the first directional coupler via the second directional coupler, the optical delay, and the optical attenuator.

The optical modulator may be operable to communicate an output signal of said optical modulator from a first output of the second directional coupler. The optical modulator may be operable to communicate the feedback optical signal from a second output of the second directional coupler. The feedback optical signal may comprise an inverted, delayed, and attenuated version of the output signal. The optical modulator may be operable to attenuate an optical signal modulated by one of the phase modulators using a second optical attenuator. A delay of the delay element and an attenuation of the optical attenuator may be configurable.

In another example embodiment of the disclosure, a method and system is described for all optical tunable equalizers. The system may comprise an optical modulator comprising phase modulators, first and second waveguides, first, second, and third directional couplers, and a delay element. The optical modulator may be operable to receive an input optical signal via the first waveguide, couple a portion of the input optical signal to the second waveguide via the first directional coupler, modulate a phase of optical signals in the input waveguide and the second waveguide using the phase modulators, couple a portion of optical signals between the first and second waveguides via the second directional coupler, thereby generating a data signal in the second waveguide and an inverted data signal in the first waveguide, delay the inverted data signal in the first waveguide using the delay element, and couple a portion of the delayed inverted data signal to the second waveguide using the third directional coupler.

The optical modulator may be operable to communicate an output signal of said optical modulator from a first output of the third directional coupler and may phase shift the data signal and the delayed inverted data signal using phase shifters in the first and second waveguides. The phase shifters may change phase of the data signal and the delayed inverted data signal at a rate slower than that of the phase modulators. The delay element may be configurable. The input optical signal may be a continuous wave signal.

While the present disclosure has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
in an optical modulator comprising an input waveguide, first and second directional couplers, phase modulators, an optical delay, and an optical attenuator:
receiving an input optical signal via the input waveguide;
coupling a portion of the input optical signal to a second waveguide via the first directional coupler;
modulating a phase of optical signals in the input waveguide and the second waveguide using the phase modulators; and
coupling a feedback optical signal to the first directional coupler via the second directional coupler, the optical delay, and the optical attenuator.

2. The method according to claim 1, comprising communicating an output signal of said optical modulator from a first output of the second directional coupler.

3. The method according to claim 2, comprising communicating the feedback optical signal from a second output of the second directional coupler.

4. The method according to claim 3, wherein the feedback optical signal comprises an inverted, delayed, and attenuated version of the output signal.

5. The method according to claim 1, comprising attenuating an optical signal modulated by one of the phase modulators using a second optical attenuator.

6. The method according to claim 1, configuring a delay of the delay element and an attenuation of the optical attenuator.

7. A system for communication, the system comprising:
an optical modulator comprising an input waveguide, first and second directional couplers, phase modulators, an optical delay, and an optical attenuator, the optical modulator being operable to:
receive an input optical signal via the input waveguide;
couple a portion of the input optical signal to a second waveguide via the first directional coupler;
modulate a phase of optical signals in the input waveguide and the second waveguide using the phase modulators; and
couple a feedback optical signal to the first directional coupler via the second directional coupler, the optical delay, and the optical attenuator.

8. The system according to claim 7, wherein the optical modulator is operable to communicate an output signal of said optical modulator from a first output of the second directional coupler.

9. The system according to claim 8, wherein the optical modulator is operable to communicate the feedback optical signal from a second output of the second directional coupler.

10. The system according to claim 9, wherein the feedback optical signal comprises an inverted, delayed, and attenuated version of the output signal.

11. The system according to claim 7, wherein the optical modulator is operable to attenuate an optical signal modulated by one of the phase modulators using a second optical attenuator.

12. The system according to claim 7, wherein a delay of the delay element and an attenuation of the optical attenuator are configurable.

13. A method for communication, the method comprising:
in an optical modulator comprising phase modulators, first and second waveguides, first, second, and third directional couplers, and a delay element:
receiving an input optical signal via the first waveguide;
coupling a portion of the input optical signal to the second waveguide via the first directional coupler;
modulating a phase of optical signals in the input waveguide and the second waveguide using the phase modulators;
coupling a portion of optical signals between the first and second waveguides via the second directional coupler, thereby generating a data signal in the second waveguide and an inverted data signal in the first waveguide;
delaying the inverted data signal in the first waveguide using the delay element; and
coupling a portion of the delayed inverted data signal to the second waveguide using the third directional coupler.

14. The method according to claim 13, comprising communicating an output signal of said optical modulator from a first output of the third directional coupler.

15. The method according to claim 13, comprising phase shifting the data signal and the delayed inverted data signal using phase shifters in the first and second waveguides.

16. The method according to claim 15, wherein the phase shifters change phase of the data signal and the delayed inverted data signal at a rate slower than the phase modulators.

17. The method according to claim 13, wherein the delay element is configurable.

18. The method according to claim 13, wherein the input optical signal is a continuous wave signal.

19. A system for communication, the system comprising:
an optical modulator comprising phase modulators, first and second waveguides, first, second, and third directional couplers, and a delay element, the optical modulator being operable to:
receive an input optical signal via the first waveguide;
couple a portion of the input optical signal to the second waveguide via the first directional coupler;
modulate a phase of optical signals in the input waveguide and the second waveguide using the phase modulators;
couple a portion of optical signals between the first and second waveguides via the second directional coupler, thereby generating a data signal in the second waveguide and an inverted data signal in the first waveguide;
delay the inverted data signal in the first waveguide using the delay element; and
couple a portion of the delayed inverted data signal to the second waveguide using the third directional coupler

20. The system according to claim 19, wherein the optical modulator is operable to communicate an output signal of said optical modulator from a first output of the third directional coupler.

21. The system according to claim 19, wherein the optical modulator is operable to phase shift the data signal and the delayed inverted data signal using phase shifters in the first and second waveguides.

22. The system according to claim 21, wherein the phase shifters change phase of the data signal and the delayed inverted data signal at a rate slower than that of the phase modulators.

23. The system according to claim 19, wherein the delay element is configurable.

24. The system according to claim 19, wherein the input optical signal is a continuous wave signal.
